(19) United States
(12) Patent Application Publication
(10) Pub. No.: US 2018/0067284 A1
(43) Pub. Date: Mar. 8, 2018

(54) PHOTOGRAPHING LENS OPTICAL SYSTEM

(71) Applicant: KOLEN CO., LTD., Gyeonggi-do (KR)

(72) Inventors: Jong Jin Lee, Seoul (KR); Chan Goo Kang, Gyeonggi-do (KR); Seong Hee Bae, Gyeonggi-do (KR)

(21) Appl. No.: 15/693,731

(22) Filed: Sep. 1, 2017

(30) Foreign Application Priority Data
Sep. 5, 2016 (KR) 10-2016-0113986

(51) Int. Cl. G02B 13/00; G02B 9/62

(52) U.S. Cl. CPC G02B 13/0045; G02B 5/208; G02B 9/62

(57) ABSTRACT

Provided is a photographing lens optical system. The photographing lens optical system includes: an aperture stop; an image sensor configured to sense an image of an object; and a plurality of lenses arranged between the object and the image sensor, wherein each of two successive lenses from among the plurality of lenses respectively include a plurality of inflection points. The plurality of lenses may include six lenses including the two successive lenses. The six lenses are plastic lenses, and some of the six lenses include a material different from materials included in other lenses among the six lenses.

### CROSS-REFERENCE TO RELATED APPLICATION

This application claims the benefit of Korean Patent Application No. 10-2016-0113986, filed on Sep. 5, 2016, in the Korean Intellectual Property Office, the disclosure of which is incorporated herein in its entirety by reference.

### BACKGROUND

### 1. Field

One or more embodiments relate to an optical system including lenses, and more particularly, to a lens optical system adopted in a camera.

### 2. Description of the Related Art

Recent cameras are mostly digital cameras including an image sensor and a lens optical system. Cameras may be used combined with other electronic devices such as communication devices. A charge-coupled device (CCD) and a complementary metal oxide semiconductor (CMOS) are widely used as image sensors.

A resolution of a camera may be affected by a post-process for processing captured images, but is mainly affected by pixel integration of the image sensor and a lens optical system. As the pixel integration of the image sensor increases, clear images may be obtained and colors of images may be represented naturally. In addition, as aberration of the lens optical system is reduced, clear and precise images may be obtained.

In order to reduce the aberration, the lens optical system includes one or more lenses, and glass lenses or plastic lenses may be used depending on a camera or a device adopting the camera.

For example, if a camera is adopted in a device such as a mobile device, lenses in a lens optical system of the camera may be mostly plastic lenses.

### SUMMARY

One or more embodiments include a photographing lens optical system capable of improving a wide angle property of a camera while maintaining advantages of a camera according to the related art.

Additional aspects will be set forth in part in the description which follows and, in part, will be apparent from the description, or may be learned by practice of the presented embodiments.

According to one or more embodiments, a photographing lens optical system includes: an aperture stop; an image sensor configured to sense an image of an object; and a plurality of lenses arranged between the object and the image sensor, wherein each of two successive lenses among the plurality of lenses include a plurality of inflection points.

The plurality of lenses may include six lenses including the two successive lenses. A first lens, a third lens, a fifth lens, and a sixth lens from among the six lenses may each have a positive refractive power. A second lens, a fourth lens, and a fifth lens from among the six lenses may each have a negative refractive power.

The six lenses may be plastic lenses, and a material included in some of the six lenses is different from materials included in other lenses from among the six lenses. A first lens, a third lens, and a sixth lens from among the six lenses may be plastic lenses including a same material. A second lens, a fourth lens, and a fifth lens from among the six lenses may be plastic lenses including a same material.

An effective viewing angle FOV of the photographing lens optical system may satisfy the following condition:

70<FOV<80.

The two successive lenses may respectively satisfy the following condition:

|Sag Min|+|Sag Max|>Sag D,

where Sag Min denotes a distance from an optical axis of the photographing lens optical system to a farthest point from the image sensor on a designated surface of a corresponding lens, Sag Max denotes a distance from the optical axis of the photographing lens optical system to a closest point from the image sensor on a designated surface of a corresponding lens, and Sag D denotes a distance from the optical axis to an end of an effective diameter of the lens.

An effective viewing angle FOV and a total length TTL of the photographing lens optical system may satisfy the following condition:

10<FOV/TTL<20.

A total length TTL of the photographing lens optical system and a diagonal length ImgH of an effective pixel area may satisfy the following condition:

0.6<TTL/ImgH<0.9.

A focal length F of the photographing lens optical system and a diagonal length ImgH of an effective pixel area may satisfy the following condition:

0.5<F/ImgH<0.7.

An F-number Fno of the photographing lens optical system may satisfy the following condition:

1.8<Fno<2.0.

The six lenses may include first to sixth lenses sequentially arranged from an object towards the image sensor, and a refractive index Ind2 of the second lens and a refractive index Ind4 of the fourth lens may satisfy the following condition:

1.5<(Ind2+Ind4)/2<1.7.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 3 are cross-sectional views of first to third photographing lens optical systems according to exemplary embodiments;

FIGS. 4 to 6 are diagrams showing longitudinal spherical aberration, astigmatic field curves, and distortion of the first photographing lens optical system of FIG. 1;

FIGS. 7 to 9 are diagrams showing longitudinal spherical aberration, astigmatic field curves, and distortion of the second photographing lens optical system of FIG. 2; and

FIGS. 10 to 12 are diagrams showing longitudinal spherical aberration, astigmatic field curves, and distortion of the third photographing lens optical system of FIG. 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, a photographing lens optical system according to embodiments of the present disclosure will be described in detail with reference to accompanying drawings. Thickness of layers and regions illustrated in the drawings are exaggerated for convenience of description. In the descriptions below, a first surface of each lens denotes an incident surface to which light is incident, and a second surface of each lens denotes an exit surface through which the light exits.

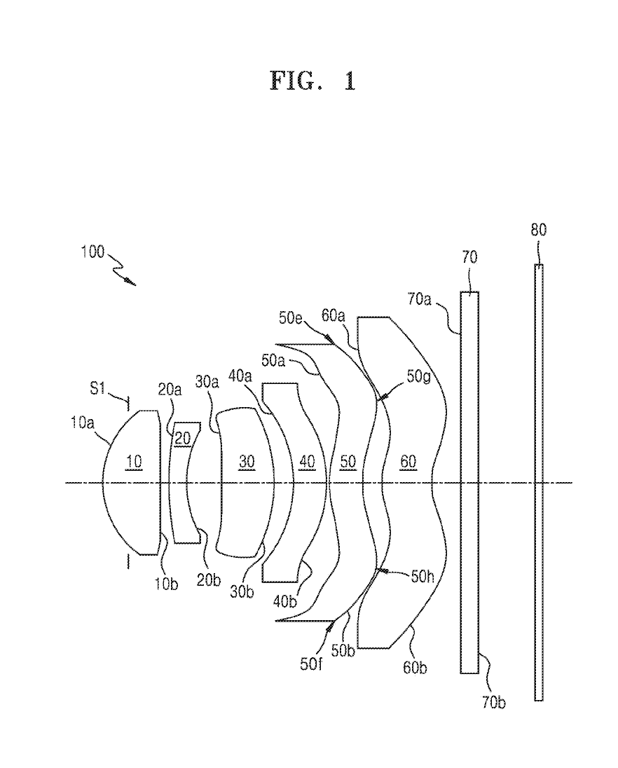

FIG. 1 shows a photographing lens optical system (hereinafter, first lens optical system 100) according to an exemplary embodiment.

Referring to FIG. 1, the first lens optical system 100 includes first to sixth lenses 10, 20, 30, 40, 50, and 60 sequentially arranged between an object (not shown) and an image sensor 80. The object is located at a left side of the first lens 10 in FIG. 1. The first to sixth lenses 10, 20, 30, 40, 50, and 60 may be plastic lenses. As another example, if necessary, some of the first to sixth lenses 10, 20, 30, 40, 50, and 60 may be glass lenses. For example, the first and second lenses 10 and 20 may be glass lenses. When the first to sixth lenses 10, 20, 30, 40, 50, and 60 are all plastic lenses, the first to sixth lenses 10, 20, 30, 40, 50, and 60 may include an identical material or different materials from one another. For example, the first, third, and sixth lenses 10, 30, and 60 may be first plastic lenses, and the second, fourth, and fifth lenses 20, 40, and 50 may be second plastic lenses. Here, the first plastic lenses may include a different material from that of the second plastic lenses.

The first to sixth lenses 10, 20, 30, 40, 50, and 60 are arranged from the object towards the image sensor 80. Light incident to the first lens 10 reaches the image sensor 80 after sequentially passing through the second to sixth lenses 20, 30, 40, 50, and 60. An infrared ray (IR) blocking unit 70 is arranged between the sixth lens 60 and the image sensor 80. The IR blocking unit 70 may be, for example, an IR blocking filter, but is not limited thereto. The IR blocking unit 70 may include a first surface 70a and a second surface 70b. An aperture stop S1 may be located between the first lens 10 and the object within a range of the first photographing lens optical system 100. For example, the aperture stop S1 may be located at a boundary of the first lens 10, and may be located adjacent to a first surface 10a of the first lens 10 to manually or automatically adjust intensity of the light incident to the first lens 10. Locations of the aperture stop S1 and the IR blocking unit 70 may be adjusted according to necessity. The image sensor 80 and the IR blocking unit 70 may be in parallel with each other. The aperture stop S1, the first to sixth lenses 10, 20, 30, 40, 50, and 60, and the IR blocking unit 70 may be arranged on an identical optical axis. The image sensor 80 may be also arranged on the optical axis.

The first lens 10 has a positive power, that is, a positive refractive power. The first surface 10a of the first lens is a curved surface convex towards the object. A second surface 10b of the first lens 10 is a curved surface having a radius of curvature that is greater than that of the first surface 10a.

The second lens 20 located at a right side of the first lens 10 has a negative power, that is, a negative refractive power. A first surface 20a of the second lens 20 may be a curved surface, a curvature of which may be smaller than that of a second surface 20b. In other words, a radius of curvature of the first surface 20a in the second lens may be greater than that of the second surface 20b. The first surface 20a of the second lens 20 may be convex towards the object. The second surface 20b of the second lens 20 is a curved surface concave towards the image sensor 80 or convex towards the object.

The third lens 30 has a positive power, that is, a positive refractive power. The third lens 30 is entirely convex towards the image sensor 80. That is, first and second surfaces 30a and 30b of the third lens 30 are curved surfaces convex towards the image sensor 80. The first and second surfaces 30a and 30b of the third lens 30 may have different curvatures from each other.

The fourth lens 40 has a negative power, that is, a negative refractive power. The fourth lens 40 is entirely convex towards the image sensor 80. That is, first and second surfaces 40a and 40b of the fourth lens 40 are curved surfaces convex towards the image sensor 80. The first and second surfaces 40a and 40b of the fourth lens 40 may have curvatures which are the same as or different from each other.

The opposite surfaces 10a and 10b of the first lens 10, the opposite surfaces 20a and 20b of the second lens 20, the opposite surfaces 30a and 30b of the third lens 30, and the opposite surfaces 40a and 40b of the fourth lens 40 may all be aspherical surfaces.

The fifth lens 50 has a positive or negative power. That is, the fifth lens 50 may have a positive refractive power or a negative refractive power. One or both of first and second surfaces 50a and 50b of the fifth lens 50 may be aspherical surfaces. At least one of the first and second surfaces 50a and 50b of the fifth lens 50 may have a plurality of inflection points. In FIG. 1, both the first and second surfaces 50a and 50b of the fifth lens 50 are shown to have a plurality of inflection points, but in another embodiment, only the first surface 50a may have a plurality of inflection points or only the second surface 50b may have a plurality of inflection points.

At a central area including the optical axis of the fifth lens 50, the first and second surfaces 50a and 50b are convex towards the subject, and regions between the central area and edges of fifth lens 50 are convex towards the image side 80. The first surface 50a may have more inflection points than the second surface 50b. In the fifth lens 50, a portion having the greatest thickness is located between the central area and the edges. Although it may not necessarily be essential, the thickness of the central area (e.g., a thickness of a portion through which the optical axis passes) may be the smallest in the fifth lens 50.

In the second surface 50b of the fifth lens 50, reference numerals 50e and 50f denote first and second locations farthest from the image sensor 80 when being measured in a direction parallel with the optical axis. A distance from the optical axis to the first location 50e or the second location 50f is referred to as “Sag Min”. In addition, in the second surface 50b of the fifth lens 50, reference numerals 50g and 50h denote third and fourth locations closest to the image sensor 80 when being measured in a direction parallel with the optical axis. A distance from the optical axis to the third location 50g or the fourth location 50h is referred to as “Sag Max”. A distance from each lens to an end of an effective diameter (aspherical coefficient) of the lens is “Sag D”, and in the fifth lens 50, Sag Min may be equal to Sag D. The above definition may be applied to surfaces of the other lenses. For example, the above definition may be applied to the second surface 60b of the sixth lens 60.

The first lens 10 may have a relatively large positive refractive power. The second to sixth lenses 20, 30, 40, 50, and 60 may act as aberration correcting lenses. A portion of the IR blocking unit 70 next to the sixth lens 60 may not contact the second surface 60b of the sixth lens 60, or may contact the second surface 60b.

A total focal length and performance of the first lens optical system 100 may vary depending on thicknesses, focal lengths, and arrangement intervals of the first to sixth lenses 10, 20, 30, 40, 50, and 60 included in the first lens optical system 100.

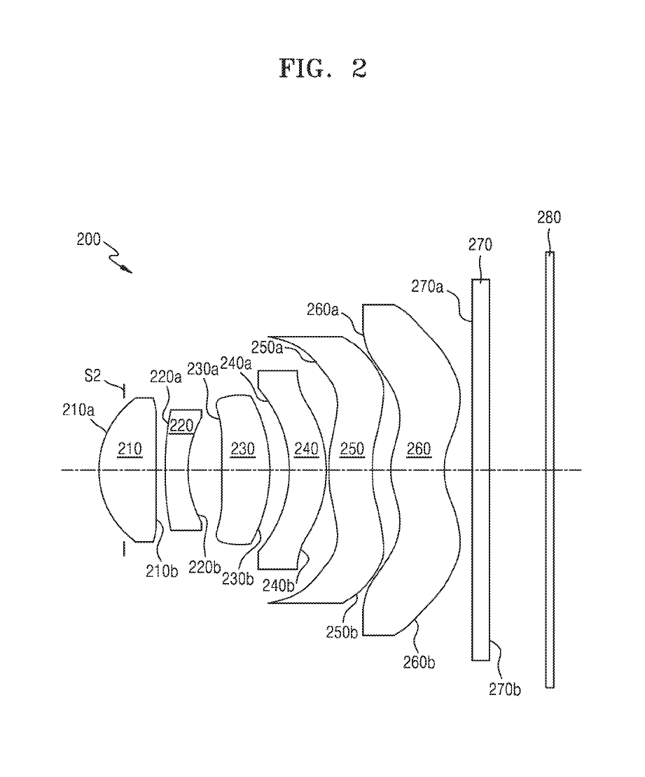

FIG. 2 shows a photographing lens optical system (hereinafter, second lens optical system 200) according to an exemplary embodiment.

Referring to FIG. 2, the second lens optical system 200 includes six aspherical lenses, that is, first to sixth lenses 210, 220, 230, 240, 250, and 260 like the first lens optical system 100, an IR blocking unit 270, an image sensor 280, and an aperture stop S2.

Opposite surfaces 210a and 220a of the first lens 210, opposite surfaces 220a and 220b of the second lens 220, opposite surfaces 230a and 230b of the third lens 230, opposite surfaces 240a and 240b of the fourth lens 240, opposite surfaces 250a and 250b of the fifth lens 250, and opposite lenses 260a and 260b of the sixth lens 260 may respectively correspond to the opposite surfaces of the first to sixth lenses 10, 20, 30, 40, 50, and 60 of the first lens optical system 100. The aperture stop S2, the IR blocking unit 270, and the image sensor 280 of the second lens optical system 200 also correspond to the aperture stop S1, the IR blocking unit 70, and the image sensor 80 of the first lens optical system 100.

Entire shapes and arrangements of the first to sixth lenses 210, 220, 230, 240, 250, and 260 of the second lens optical system 200 and the first to sixth lenses 10, 20, 30, 40, 50, and 60 of the first lens optical system 100 may be the same as or similar to each other.

However, optical characteristics (e.g., refractive index, radius of curvature, Abbe's number, aspherical coefficients, etc.) of the lenses in the first and second lens optical systems 100 and 200 may be slightly different from each other as will be shown in Tables and aberration diagrams later.

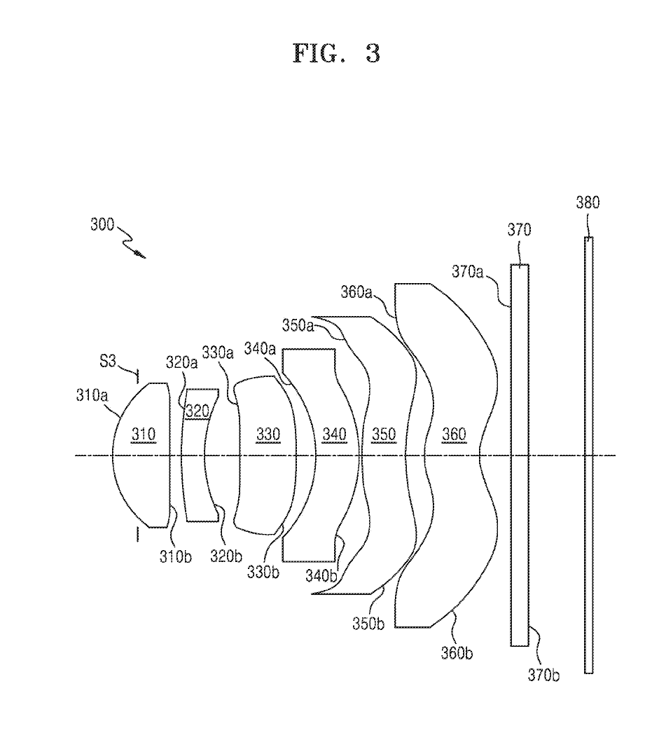

FIG. 3 shows a photographing lens optical system (hereinafter, third lens optical system 300) according to an exemplary embodiment.

Referring to FIG. 3, the third lens optical system 300 includes six lenses, that is, first to sixth lenses 310, 320, 330, 340, 350, and 360. Also, the third lens optical system 300 includes an aperture stop S3, an IR blocking unit 370, and an image sensor 380.

Opposite surfaces 310a and 320a of the first lens 310, opposite surfaces 320a and 320b of the second lens 320, opposite surfaces 330a and 330b of the third lens 330, opposite surfaces 340a and 340b of the fourth lens 340, opposite surfaces 350a and 350b of the fifth lens 350, and opposite lenses 360a and 360b of the sixth lens 360 may respectively correspond to the opposite surfaces of the first to sixth lenses 10, 20, 30, 40, 50, and 60 of the first lens optical system 100. The aperture stop S3, the IR blocking unit 370, and the image sensor 380 of the third lens optical system 300 also correspond to the aperture stop S1, the IR blocking unit 70, and the image sensor 80 of the first lens optical system 100.

Entire shapes and arrangements of the first to sixth lenses 310, 320, 330, 340, 350, and 360 of the third lens optical system 300 and the first to sixth lenses 10, 20, 30, 40, 50, and 60 of the first lens optical system 100 may be the same as or similar to each other.

However, optical characteristics (e.g., refractive index, radius of curvature, Abbe's number, aspherical coefficients, etc.) of the lenses in the first and third lens optical systems 100 and 300 may be slightly different from each other as will be shown in Tables and aberration diagrams later.

Next, optical characteristics of each element in the first to third lens optical systems 100, 200, and 300 will be described below in detail.

Table 1 below illustrates radius of curvature (R), lens thicknesses, distances among lenses, distances (T) among adjacent members, refractive index Nd, and Abbe's number Vd of the elements 10, 20, 30, 40, 50, 60, 70, and 80 included in the first lens optical system 100. The refractive index Nd denotes a refractive index of each lens measured by using a d-line. In addition, the Abbe number denotes an Abbe number of a lens with respect to the d-line. In the reference numerals of the lens surfaces, * denotes that the corresponding lens surface is an aspherical surface. In addition, values of R and T are expressed in units of mm.

TABLE 1

| Elements | Surfaces | R | T | Nd | Vd |
|---|---|---|---|---|---|
| aperture stop | S1 | Infinity | −0.2800 | | |
| first lens 10 | 10a* | 1.5752 | 0.6282 | 1.546 | 56.093 |
| | 10b* | 11.4317 | 0.1023 | | |
| second lens 20 | 20a* | 3.9973 | 0.2000 | 1.656 | 21.474 |
| | 20b* | 2.1329 | 0.4085 | | |
| third lens 30 | 30a* | 42.4762 | 0.5673 | 1.546 | 56.093 |
| | 30b* | −7.9881 | 0.2564 | | |
| fourth lens 40 | 40a* | −2.1805 | 0.3490 | 1.656 | 21.474 |
| | 40b* | −3.5115 | 0.0300 | | |
| fifth lens 50 | 50a* | 2.7965 | 0.3821 | 1.656 | 21.474 |
| | 50b* | 2.4942 | 0.2170 | | |
| sixth lens 60 | 60a* | 1.2479 | 0.5613 | 1.546 | 56.093 |
| | 60b* | 1.2438 | 0.3292 | | |
| IR blocking unit 70 | 70a | Infinity | 0.2100 | | |
| | 70b | Infinity | 0.6329 | | |
| image sensor 80 | IMG | Infinity | −0.0030 | | |

The aspherical surface of each lens in the first lens optical system 100 satisfies following aspheric surface equation 1.

$$Z = \frac{{Y}^{2}}{R ( 1 + \sqrt{1 - ( 1 + K ) {Y}^{2} / {R}^{2}}} + {AY}^{4} + {BY}^{6} + {CY}^{8} + {DY}^{10} + {EY}^{12} + {FY}^{14} + {GY}^{16} + {HY}^{18} + {JY}^{20}$$

In Equation 1, Z denotes a distance from a vertex of each lens in an optical axis direction, Y denotes a distance in a direction perpendicular to the optical axis, R denotes a radius of curvature, K denotes a conic constant, and A, B, C, D, E, F, G, H, and J denote aspherical coefficients.

Table 2 below illustrates aspherical coefficients of the lenses 10, 20, 30, 40, 50, and 60 included in the first lens optical system 100.

TABLE 2

| Surfaces | K | A | B | C | D | E |
|---|---|---|---|---|---|---|
| 10a* | −0.2096 | 0.0047 | 0.0209 | −0.0956 | 0.2308 | −0.3124 |
| 10b* | 0.0000 | −0.1099 | 0.2130 | −0.2843 | 0.2318 | −0.1488 |
| 20a* | −62.2313 | −0.1244 | 0.2226 | 0.0199 | −0.5617 | 0.8868 |
| 20b* | 4.0089 | −0.2271 | 0.3527 | −0.6114 | 1.0407 | −1 .6596 |
| 30a* | 0.0000 | −0.0873 | 0.0708 | −0.3617 | 0.8259 | −0.9914 |
| 30b* | 28.8748 | −0.1913 | 0.4793 | −1.0611 | 1.5161 | −1.1802 |
| 40a* | −0.1897 | −0.4068 | 1.3433 | −2.6055 | 3.3604 | −2.5321 |
| 40b* | −28.6864 | −0.5214 | 1.1420 | −1.8717 | 2.0381 | −1.3359 |
| 50a* | 0.0000 | 0.0021 | −0.1007 | 0.0260 | 0.0018 | −0.0008 |
| 50b* | −17.0612 | 0.0806 | −0.1189 | 0.0515 | −0.0101 | −0.0005 |
| 60a* | −7.1458 | −0.2031 | −0.0765 | 0.2061 | −0.1413 | 0.0505 |
| 60b* | −0.9866 | −0.3722 | 0.1791 | −0.0834 | 0.0248 | −0.0046 |

| Surfaces | F | G | H | J |
|---|---|---|---|---|
| 10a* | 0.2141 | −0.0640 | 0.0000 | 0.0000 |
| 10b* | 0.0647 | −0.0163 | 0.0000 | 0.0000 |
| 20a* | −0.6111 | 0.1712 | 0.0000 | 0.0000 |
| 20b* | 1.6066 | −0.6918 | 0.0000 | 0.0000 |
| 30a* | 0.4591 | 0.0000 | 0.0000 | 0.0000 |
| 30b* | 0.3937 | −0.0271 | 0.0000 | 0.0000 |
| 40a* | 0.9787 | −0.1492 | 0.0000 | 0.0000 |
| 40b* | 0.5094 | −0.1045 | 0.0089 | 0.0000 |
| 50a* | 0.0000 | 0.0000 | 0.0000 | 0.0000 |
| 50b* | 0.0006 | −6.4036e−005 | 0.0000 | 0.0000 |
| 60a* | −0.0101 | 0.0011 | −4.7065e−005 | 0.0000 |
| 60b* | 0.0005 | −1.9694e−005 | 0.0000 | 0.0000 |

When the optical characteristics of the elements included in the first lens optical system 100 are as shown in Table 1 and Table 2, an F-number of the first lens optical system 100 is 1.89 and a focal length f of the first lens optical system 100 is about 3.99 mm.

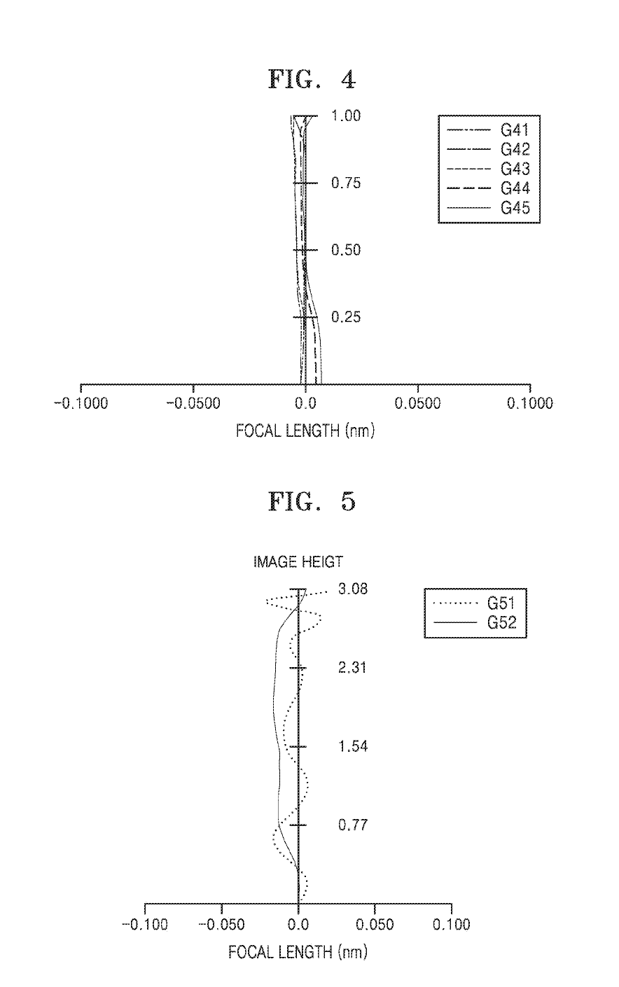

FIG. 4 shows longitudinal spherical aberration of the first lens optical system 100, when the lenses included in the first lens optical system 100 have sizes and aspherical coefficients according to Table 1 and Table 2. In FIG. 4, a first graph G41 shows a result when a wavelength of incident light is 470.0000 nm, a second graph G42 shows a result when a wavelength of incident light is 510.0000 nm, a third graph G43 shows a result when a wavelength of incident light is 555.0000 nm, a fourth graph G44 shows a result when a wavelength of incident light is 610.0000 nm, and a fifth graph G45 shows a result when a wavelength of incident light is 650.0000 nm.

FIG. 5 shows astigmatic field curves of the first lens optical system 100, when the lenses included in the first lens optical system 100 have sizes and aspherical coefficients according to Table 1 and Table 2. FIG. 5 shows a result when light having a wavelength of 555.0000 nm is used.

In FIG. 5, a first graph G51 shows a tangential field curvature, and a second graph G52 shows a sagittal field curvature.

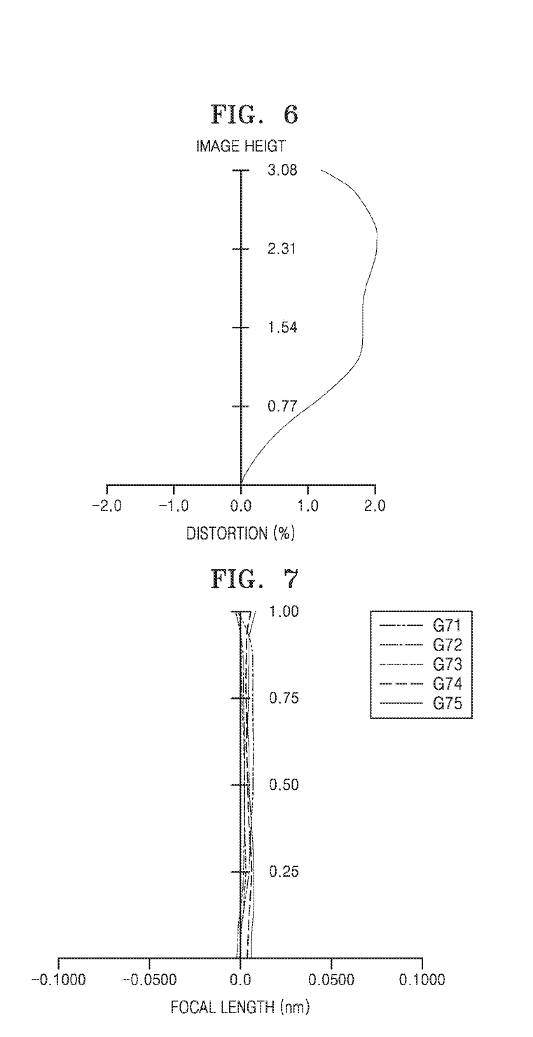

FIG. 6 shows distortion of the first lens optical system 100, when the lenses included in the first lens optical system 100 have sizes and aspherical coefficients according to Table 1 and Table 2. FIG. 6 shows a result when light having a wavelength of 555.0000 nm is used.

Table 3 below illustrates radius of curvature (R), lens thicknesses, distances among lenses, distances (T) among adjacent members, refractive index Nd, and Abbe's number Vd of the elements 210, 220, 230, 240, 250, 260, 270, and 280 included in the second lens optical system 200. The refractive index Nd denotes a refractive index of each lens measured using a d-line. In addition, the Abbe number denotes an Abbe number of a lens with respect to the d-line. In the reference numerals of the lens surfaces, * denotes that the corresponding lens surface is an aspherical surface. In addition, values of R and T are expressed in units of mm.

TABLE 3

| Elements | Surfaces | R | T | Nd | Vd |
|---|---|---|---|---|---|
| aperture stop | S2 | Infinity | −0.2700 | | |
| first lens 210 | 210a* | 1.6425 | 0.6077 | 1.546 | 56.093 |
| | 210b* | 14.2830 | 0.1100 | | |
| second lens 220 | 220a* | 4.1602 | 0.2449 | 1.656 | 21.474 |
| | 220b* | 2.1573 | 0.3711 | | |
| third lens 230 | 230a* | 11.0953 | 0.5312 | 1.546 | 56.093 |
| | 230b* | −10.1128 | 0.2542 | | |
| fourth lens 240 | 240a* | −1.9821 | 0.3825 | 1.656 | 21.474 |
| | 240b* | −3.2462 | 0.0300 | | |
| fifth lens 250 | 250a* | 3.3773 | 0.4735 | 1.656 | 21.474 |
| | 250b* | 3.2329 | 0.2074 | | |
| sixth lens 260 | 260a* | 1.3426 | 0.5852 | 1.546 | 56.093 |
| | 260b* | 1.2615 | 0.2998 | | |
| IR blocking unit 270 | 270a | Infinity | 0.2100 | | |
| | 270b | Infinity | 0.6217 | | |
| image sensor 280 | IMG | Infinity | 0.0030 | | |

The aspherical surface of each lens in the second lens optical system 200 satisfies the aspheric surface equation 1 provided above.

Table 4 below illustrates aspherical coefficients of the lenses 210, 220, 230, 240, 250, and 260 included in the second lens optical system 200.

TABLE 4

| Surfaces | K | A | B | C | D | E |
|---|---|---|---|---|---|---|
| 210a* | −0.3565 | 0.0051 | 0.0089 | −0.0603 | 0.1317 | −0.1731 |
| 210b* | 0.0000 | −0.1091 | 0.2115 | −0.3374 | 0.3687 | −0.3186 |
| 220a* | −45.7932 | −0.1291 | 0.2913 | −0.2430 | −0.0093 | 0.2336 |
| 220b* | 3.9521 | −0.2007 | 0.2659 | −0.2755 | 0.0611 | 0.1043 |
| 230a* | −0.1032 | 0.1063 | −0.4452 | 0.9489 | −1.0879 | 0.4953 |
| 230b* | 41.2550 | −0.1977 | 0.3910 | −0.8144 | 1.0778 | −0.7236 |
| 240a* | −0.7941 | −0.3636 | 1.1904 | −2.3258 | 3.0947 | −2.4459 |
| 240b* | −28.7507 | −0.4527 | 0.9402 | −1 .4546 | 1.5482 | −1.0193 |
| 250a* | 0.0000 | 0.0058 | −0.0897 | 0.0233 | 0.0009 | −0.0006 |
| 250b* | −17.0173 | 0.0398 | −0.0647 | 0.0206 | −0.0029 | −0.0003 |
| 260a* | −6.9023 | −0.2215 | −0.0094 | 0.1366 | −0.1108 | 0.0445 |
| 260b* | −0.9090 | −0.3696 | 0.2013 | −0.0893 | 0.0274 | −0.0052 |

| Surfaces | F | G | H | J |
|---|---|---|---|---|
| 210a* | 0.1091 | −0.0323 | 0.0000 | 0.0000 |
| 210b* | 0.1669 | −0.0391 | 0.0000 | 0.0000 |
| 220a* | −0.2032 | 0.0665 | 0.0000 | 0.0000 |
| 220b* | −0.0994 | −0.0037 | 0.0000 | 0.0000 |
| 230a* | 0.0000 | 0.0000 | 0.0000 | 0.0000 |
| 230b* | 0.1385 | 0.0355 | 0.0000 | 0.0000 |
| 240a* | 1.0061 | −0.1651 | 0.0000 | 0.0000 |
| 240b* | 0.3994 | −0.0860 | 0.0078 | 0.0000 |
| 250a* | 0.0000 | 0.0000 | 0.0000 | 0.0000 |
| 250b* | 0.0002 | −3.1504e−005 | 0.0000 | 0.0000 |
| 260a* | −0.0098 | 0.0011 | −5.3246e−005 | 0.0000 |
| 260b* | 0.0005 | −2.3712e−005 | 0.0000 | 0.0000 |

When the optical characteristics of the elements included in the second lens optical system 200 are as shown in Table 3 and Table 444, an F-number of the second lens optical system 200 is 1.89 and a focal length f of the second lens optical system 200 is about 3.99 mm.

FIG. 7 shows longitudinal spherical aberration of the second lens optical system 200, when the lenses included in the second lens optical system 200 have sizes and aspherical coefficients according to Table 3 and Table 4.

In FIG. 7, a first graph G71 shows a result when a wavelength of incident light is 470.0000 nm, a second graph G72 shows a result when a wavelength of incident light is 510.0000 nm, a third graph G73 shows a result when a wavelength of incident light is 555.0000 nm, a fourth graph G74 shows a result when a wavelength of incident light is 610.0000 nm, and a fifth graph G75 shows a result when a wavelength of incident light is 650.0000 nm.

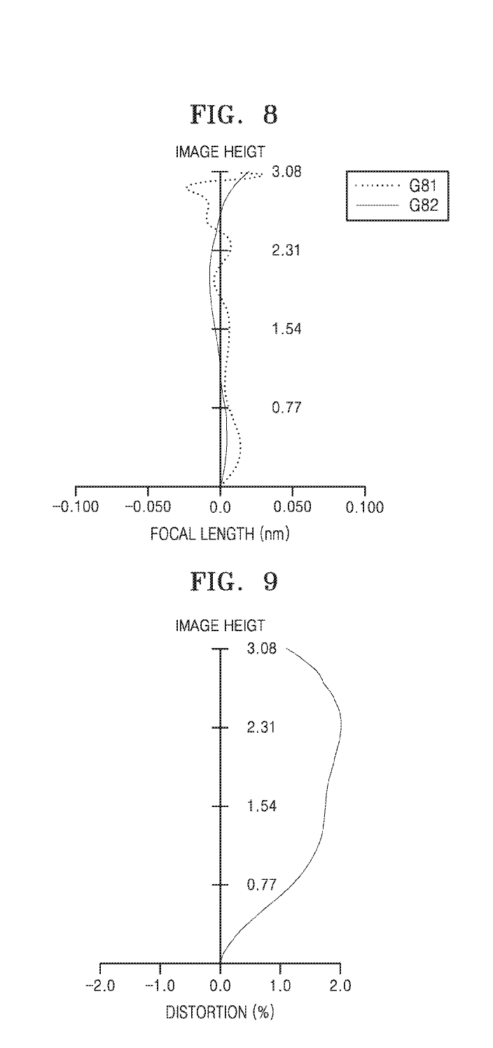

FIG. 8 shows astigmatic field curves of the second lens optical system 200, when the lenses included in the second lens optical system 200 have sizes and aspherical coefficients according to Table 3 and Table 4. FIG. 8 shows a result when light having a wavelength of 555.0000 nm is used.

In FIG. 8, a first graph G51 shows tangential field curvature, and a second graph G52 shows sagittal field curvature.

FIG. 9 shows distortion of the second lens optical system 200, when the lenses included in the second lens optical system 200 have sizes and aspherical coefficients according to Table 3 and Table 4. FIG. 9 shows a result when light having a wavelength of 555.0000 nm is used.

Table 5 below illustrates radius of curvature (R), lens thicknesses, distances among lenses, distances (T) among adjacent members, refractive index Nd, and Abbe's number Vd of the elements 310, 320, 330, 340, 350, 360, 370, and 380 included in the third lens optical system 300. The refractive index Nd denotes a refractive index of each lens measured using a d-line. In addition, the Abbe's number denotes an Abbe's number of a lens with respect to the d-line. In the reference numerals of the lens surfaces, * denotes that the corresponding lens surface is an aspherical surface. In addition, values of R and T are expressed in units of mm.

TABLE 5

| Elements | Surfaces | R | T | Nd | Vd |
|---|---|---|---|---|---|
| aperture stop | S3 | Infinity | −0.2396 | | |
| first lens 310 | 310a* | 1.6083 | 0.6423 | 1.546 | 56.093 |
| | 310b* | 13.9169 | 0.1000 | | |
| second lens 320 | 320a* | 4.2552 | 0.2228 | 1.656 | 21.474 |
| | 320b* | 2.2549 | 0.3719 | | |
| third lens 330 | 330a* | 14.7420 | 0.5682 | 1.546 | 56.093 |
| | 330b* | −11.7380 | 0.1969 | | |
| fourth lens 340 | 340a* | −2.6426 | 0.4291 | 1.656 | 21.474 |
| | 340b* | −5.5148 | 0.3000 | | |
| fifth lens 350 | 350a* | 3.8311 | 0.4547 | 1.656 | 21.474 |
| | 350b* | 4.4749 | 0.1818 | | |
| sixth lens 360 | 360a* | 1.3783 | 0.5611 | 1.546 | 56.093 |
| | 360b* | 1.2090 | 0.3000 | | |
| IR blocking unit 370 | 370a | Infinity | 0.2100 | | |
| | 370b | Infinity | 0.6287 | | |
| image sensor 380 | IMG | Infinity | 0.0030 | | |

The aspherical surface of each lens in the third lens optical system 300 satisfies the aspheric surface equation 1 provided above.

Table 6 below illustrates aspherical coefficients of the lenses 310, 320, 330, 340, 350, and 360 included in the third lens optical system 300.

TABLE 6

| Surfaces | K | A | B | C | D | E |
|---|---|---|---|---|---|---|
| 310a* | −0.3156 | 0.0023 | 0.0250 | −0.1000 | 0.1929 | −0.2288 |
| 310b* | 0.0000 | −0.0877 | 0.1149 | −0.0673 | −0.1075 | 0.1844 |
| 320a* | −40.8852 | −0.1111 | 0.2373 | −0.2150 | 0.1678 | −0.1812 |
| 320b* | 4.0796 | −0.1678 | 0.2568 | −0.5136 | 1.0833 | −1.7461 |
| 330a* | 0.0000 | −0.0808 | 0.0647 | −0.3282 | 0.6520 | −0.7142 |
| 330b* | 58.9137 | −0.1588 | 0.3038 | −0.5692 | 0.5972 | −0.3300 |
| 340a* | 0.4977 | −0.2826 | 0.9090 | −1 .6546 | 1.9577 | −1.3979 |
| 340b* | −28.7506 | −0.3575 | 0.7375 | −1.1095 | 1.0955 | −0.6428 |
| 350a* | 0.0000 | 0.0303 | −0.1052 | 0.0261 | 0.0019 | −0.0008 |
| 350b* | −17.0173 | 0.0739 | −0.1073 | 0.0457 | −0.0104 | 0.0005 |
| 360a* | −6.9084 | −0.2057 | −0.0416 | 0.1384 | −0.0907 | 0.0313 |
| 360b* | −0.9892 | −0.3674 | 0.1965 | −0.0862 | 0.0263 | −0.0049 |

| Surfaces | F | G | H | J |
|---|---|---|---|---|
| 310a* | 0.1384 | −0.0377 | 0.0000 | 0.0000 |
| 310b* | −0.1089 | 0.0209 | 0.0000 | 0.0000 |
| 320a* | 0.1958 | −0.0801 | 0.0000 | 0.0000 |
| 320b* | 1.5838 | −0.5928 | 0.0000 | 0.0000 |
| 330a* | 0.3257 | 0.0000 | 0.0000 | 0.0000 |
| 330b* | 0.0500 | 0.0187 | 0.000 | 0.0000 |
| 340a* | 0.5359 | −0.0848 | 0.0000 | 0.0000 |
| 340b* | 0.2176 | −0.0396 | 0.0030 | 0.0000 |
| 350a* | 0.0000 | 0.0000 | 0.0000 | 0.0000 |
| 350b* | 0.0003 | −3.8792e−005 | 0.0000 | 0.0000 |
| 360a* | −0.0061 | 0.0006 | −2.7791e−005 | 0.0000 |
| 360b* | 0.0005 | −2.0507e−005 | 0.0000 | 0.0000 |

When the optical characteristics of the elements included in the third lens optical system 300 are as shown in Table 5 and Table 6, an F-number of the third lens optical system 300 is 1.89 and a focal length f of the third lens optical system 300 is about 3.99 mm.

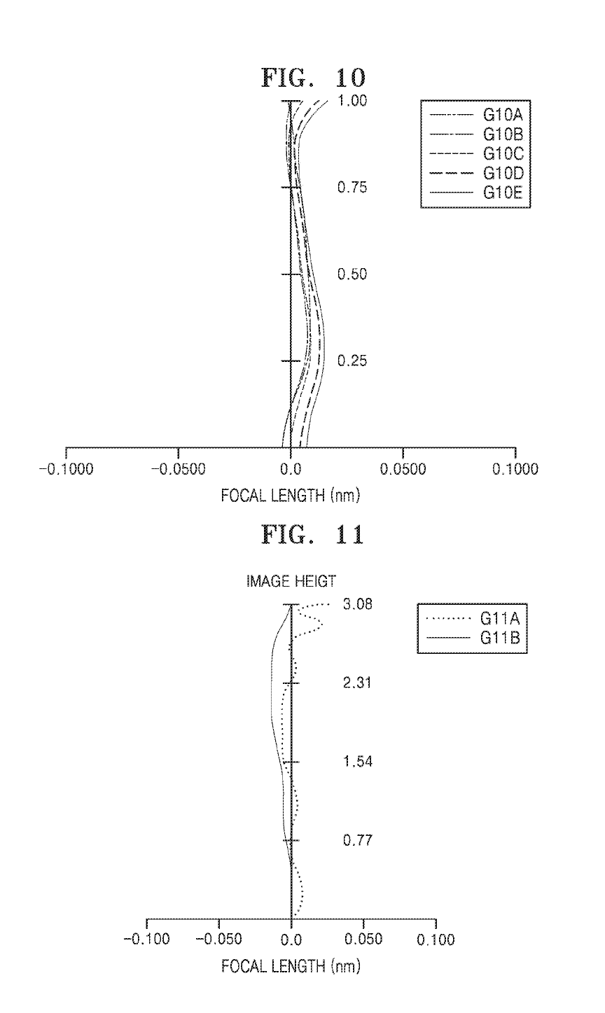

FIG. 10 shows longitudinal spherical aberration of the third lens optical system 300, when the lenses included in the second lens optical system 200 have sizes and aspherical coefficients according to Table 5 and Table 6. In FIG. 10, a first graph G10A shows a result when a wavelength of incident light is 470.0000 nm, a second graph G10B shows a result when a wavelength of incident light is 510.0000 nm, a third graph G10C shows a result when a wavelength of incident light is 555.0000 nm, a fourth graph G10D shows a result when a wavelength of incident light is 610.0000 nm, and a fifth graph G10E shows a result when a wavelength of incident light is 650.0000 nm.

FIG. 11 shows astigmatic field curves of the third lens optical system 300, when the lenses included in the third lens optical system 300 have sizes and aspherical coefficients according to Table 5 and Table 6. FIG. 11 shows a result when light having a wavelength of 555.0000 nm is used.

In FIG. 11, a first graph G11A shows tangential field curvature, and a second graph G11B shows sagittal field curvature.

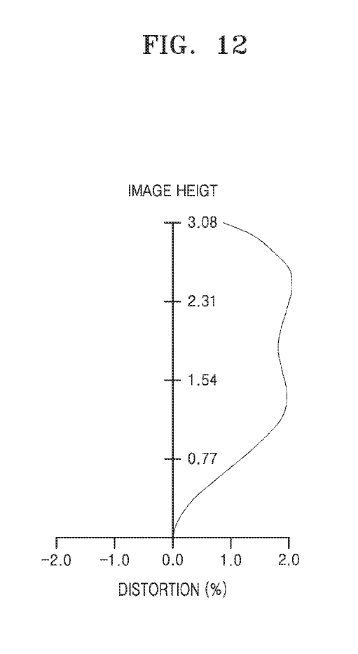

FIG. 12 shows distortion of the third lens optical system 300, when the lenses included in the third lens optical system 300 have sizes and aspherical coefficients according to Table 5 and Table 6. FIG. 12 shows a result when light having a wavelength of 555.0000 nm is used.

The first to third lens optical systems 100, 200, and 300 satisfy at least one of following Conditions 2 to 8.

70<FOV<80 (2)

In Condition 2, FOV denotes an effective viewing angle of a photographing lens optical system.

When the photographing lens optical system satisfies Condition 2, the photographing lens optical system may have a wide angle lens function having a wide viewing angle.

|Sag Min|+|Sag Max|>SagD (3)

In Condition 3, Sag Min, Sag Max, and Sag D are as defined in the above description of the fifth lens 50 of the first lens optical system 100. The above Condition 3 may denote whether each lens has an inflection point. For example, the above Condition 3 may denote whether the incident surfaces 50a, 250a, and 350a or the exit surfaces 50b, 250b, and 350b of the fifth lenses 50, 250, and 350 have an inflection point. If a lens has no inflection point, a value of |Sag Min|+|Sag Max| is equal to a value of Sag D. Therefore, a lens having no inflection point does not satisfy Condition 3.

10<FOV/TTL<20 (4)

In above Condition 4, TTL denotes a distance between a center of the first surface 10a of the first lens 10 and the image sensor 80 measured along the optical axis. The above Condition 4 restricts a ratio of a viewing angle with respect to a length of the photographing lens optical system. When the photographing lens optical system satisfies Condition 4, the photographing lens optical system having an ultra-small size and a relatively wide viewing angle may be implemented.

0.6<TTL/ImgH<0.9 (5)

In Condition 5, ImgH denotes a diagonal length of an effective pixel area. The above Condition 5 defines a ratio of a total length of the photographing lens optical system with respect to an image size. In addition, Condition 5 denotes a relationship between a size of the first lens optical system 100 and aberration correction, that is, as a value of TTL/ImgH approaches the minimum value, the first lens optical system 100 may become slimmer, but this may be disadvantageous for correcting the aberration.

On the other hand, as the value of TTL/ImgH approaches the maximum value, this may be advantageous for correcting the aberration, but it may be difficult to make the first lens optical system 100 slim. Therefore, as the above value approaches the minimum value within the range of Condition 5, it is easy to manufacture a compact optical system, but difficult to implement sufficient performance, and as the above value approaches the maximum value within the range of Condition 5, it may be easy to implement the performance, but may not be easy to manufacture a compact lens optical system.

0.5<F/ImgH<0.7 (6)

In Condition 6, F denotes a focal length of the photographing lens optical system.

The above Condition 6 defines a ratio of the focal length with respect to an image size. As it gets closer to the minimum value within the range of Condition 6, a lens optical system having a short focal length may be implemented, but it may be difficult to control aberration. On the other hand, as it gets closer to the maximum value within the range of Condition 6, it may be easy to control the aberration, but difficult to optimize the lens optical system having a short focal length.

1.8<Fno<2.0 (7)

In Condition 7, Fno denotes an F-number of the photographing lens optical system.

Condition 7 defines the F-number of the photographing lens optical system, and represents brightness of the photographing lens optical system. When the photographing lens optical system satisfies Condition 7, brightness that a lens optical system having six plastic lenses according to the related art may not obtain may be implemented, and thus, brighter images may be obtained.

1.5<(Ind2+Ind4)/2<1.7 (8)

In Condition 8, Ind2 denotes a refractive index of the second lens 20, 220, and 320 in the first to third photographing lens optical systems 100, 200, and 300. In addition, Ind4 denotes a refractive index of the fourth lenses 40, 240, and 340 in the first to third photographing lens optical systems 100, 200, and 300.

The above Condition 8 defines materials included in the second lenses 20, 220, and 320 and the fourth lenses 40, 240, and 340 in the first to third photographing lens optical systems 100, 200, and 300, that is, a plastic material that is highly refractive is used to easily control aberration and reduce costs.

Table 7 below shows values of the first to third photographing lens optical systems 100, 200, and 300 according to Conditions 2 to 8.

TABLE 7

| | | condition 3 | | | | | |
|---|---|---|---|---|---|---|---|
| | condition 2 | \|Sag Min\| + \|Sag | condition 4 | condition 5 | condition 6 | condition 7 | condition 8 |
| | FOV | Max\| > SagD | FOV/TTL | TTL/ImgH | F/ImgH | Fno | (Ind2 + Ind4)/2 |
| first lens | 74.609 | 0.1514 | 15.316 | 0.7920782 | 0.6487805 | 1.890 | 1.6557434 |
| optical | | | | | | | |
| system | | | | | | | |
| second lens | 74.601 | 0.1006 | 15.125 | 0.8019983 | 0.6487805 | 1.890 | 1.6557434 |
| optical | | | | | | | |
| system | | | | | | | |
| third lens | 74.601 | 0.0924 | 15.223 | 0.7968453 | 0.6501463 | 1.890 | 1.6557434 |
| optical | | | | | | | |
| system | | | | | | | |

Referring to Table 7 above, the first to third photographing lens optical systems 100, 200, and 300 satisfy Conditions 2 to 8.

As described above, the first to third lens optical systems 100, 200, and 300 respectively include six lenses arranged between the object and the image sensor. In the above arrangement, the second lenses 20, 220, and 320 and the fourth lenses 40, 240, and 340 have negative refractive powers. In addition, the fifth lenses 50, 250, and 350 and the sixth lenses 60, 260, and 360 are aspherical lenses each having a plurality of inflection points. Therefore, it is easy to correct various aberrations, and a wide angle photographing operation may be performed when compared with a six-lens optical system according to the related art. Also, since each lens is a plastic lens, manufacturing costs may be reduced relative to glass lenses, and manufacturing processes may be simplified.

The photographing lens optical system may be applied not only to mobile communication devices, but also to a lens optical system in recording devices or photographing devices for obtaining images of an object.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A photographing lens optical system comprising:
an aperture stop;
an image sensor configured to sense an image of an object; and
a plurality of lenses arranged between the object and the image sensor,
wherein each of two successive lenses among the plurality of lenses include a plurality of inflection points.

2. The photographing lens optical system of claim 1, wherein the plurality of lenses comprise six lenses including the two successive lenses.

3. The photographing lens optical system of claim 2, wherein a first lens, a third lens, a fifth lens, and a sixth lens from among the six lenses each have a positive refractive power.

4. The photographing lens optical system of claim 2, wherein a second lens, a fourth lens, and a fifth lens from among the six lenses each have a negative refractive power.

5. The photographing lens optical system of claim 2, wherein the six lenses are plastic lenses, and a material included in some of the six lenses is different from materials included in other lenses from among the six lenses.

6. The photographing lens optical system of claim 5, wherein a first lens, a third lens, and a sixth lens from among the six lenses are plastic lenses including a same material.

7. The photographing lens optical system of claim 5, wherein a second lens, a fourth lens, and a fifth lens from among the six lenses are plastic lenses including a same material.

8. The photographing lens optical system of claim 1, wherein an effective viewing angle FOV of the photographing lens optical system satisfies the following condition:
70<FOV<80.

9. The photographing lens optical system of claim 1, wherein the two successive lenses respectively satisfy the following condition:

|Sag Min|+|Sag Max|>Sag D,
where Sag Min denotes a distance from an optical axis of the photographing lens optical system to a farthest point from the image sensor on a designated surface of a corresponding lens,
Sag Max denotes a distance from the optical axis of the photographing lens optical system to a closest point from the image sensor on a designated surface of a corresponding lens, and
Sag D denotes a distance from the optical axis to an end of an effective diameter of the lens.

10. The photographing lens optical system of claim 1, wherein an effective viewing angle FOV and a total length TTL of the photographing lens optical system satisfy the following condition:
10<FOV/TTL<20.

11. The photographing lens optical system of claim 1, wherein a total length TTL of the photographing lens optical system and a diagonal length ImgH of an effective pixel area satisfy the following condition:
0.6<TTL/ImgH<0.9.

12. The photographing lens optical system of claim 1, wherein a focal length F of the photographing lens optical system and a diagonal length ImgH of an effective pixel area satisfy the following condition:
0.5<F/ImgH<0.7.

13. The photographing lens optical system of claim 1, wherein an F-number Fno of the photographing lens optical system satisfies the following condition:
1.8<Fno<2.0.

14. The photographing lens optical system of claim 2, wherein the six lenses comprise first to sixth lenses sequentially arranged from an object towards the image sensor, and a refractive index Ind2 of the second lens and a refractive index Ind4 of the fourth lens satisfy the following condition:
1.5<(Ind2+Ind4)/2<1.7.
